(19) United States
(12) Patent Application Publication
(10) Pub. No.: US 2002/0039365 A1
(43) Pub. Date: Apr. 4, 2002

(54) Pipelined searches with a cache table

(75) Inventors: Paul Kalpathy, Springfield, MO (US); Mike Jorda, Fremont, CA (US)

Correspondence Address: ARENT FOX KINTNER PLOTKIN & KAHN, 1050 CONNECTICUT AVENUE, N.W., SUITE 600, WASHINGTON, DC, 20036, US

(73) Assignee: Broadcom Corporation

(21) Appl. No.: 09/985,763

(22) Filed: Nov. 6, 2001

Related U.S. Application Data
(63) Continuation-in-part of application No. 09/528,164, filed on Mar. 17, 2000.
(60) Provisional application No. 60/124,878, filed on Mar. 17, 1999.
(60) Provisional application No. 60/135,603, filed on May 24, 1999.
(60) Provisional application No. 60/149,706, filed on Aug. 20, 1999.

(51) Int. Cl. H04L 12/56

(52) U.S. Cl. 370/389; 370/392; 370/216

(57) ABSTRACT

The invention is table search device having a table that has a plurality of entries and a cache having a subset of entries of the plurality of entries of the table. A search engine is configured to first search the cache in a first number of search cycles and then search the table in a second number of search cycles based on search results of the cache. The search engine connected to the table and the cache.

### REFERENCES TO RELATED APPLICATIONS

This application is a divisional application of U.S. patent application Ser. No. 09/528,164 filed on Mar. 17, 2000 which is a continuation-in-part (CIP) of U.S. patent application Ser. No. 09/343,409, filed on Jun. 30, 1999. U.S. patent application Ser. No. 09/528,164 filed on Mar. 17, 2000 claims priority of U.S. Provisional Application Serial No. 60/124,878, filed on Mar. 17, 1999, U.S. Provisional Application Serial No. 60/135,603, filed on May 24, 1999, and U.S. Provisional Application Serial No. 60/149,706, filed on Aug. 20, 1999. The subject matter of these earlier filed applications is hereby incorporated by reference.

### BACKGROUND OF THE INVENTION

1. Field of the Invention

The invention relates to a method and apparatus for high performance switching in local area communications networks such as token ring, ATM, ethernet, fast ethernet, and gigabit ethernet environments. In particular, the invention relates to a new switching architecture in an integrated, modular, single chip solution, which can be implemented on a semiconductor substrate such as a silicon chip.

2. Description of the Related Art

As computer performance has increased in recent years, the demands on computer networks has significantly increased; faster computer processors and higher memory capabilities need networks with high bandwidth capabilities to enable high speed transfer of significant amounts of data. The well-known ethernet technology, which is based upon numerous IEEE ethernet standards, is one example of computer networking technology which has been able to be modified and improved to remain a viable computing technology. A more complete discussion of prior art networking systems can be found, for example, in SWITCHED AND FAST ETHERNET, by Breyer and Riley (Ziff-Davis, 1996), and numerous IEEE publications relating to IEEE 802 standards. Based upon the Open Systems Interconnect (OSI) 7-layer reference model, network capabilities have grown through the development of repeaters, bridges, routers, and, more recently, “switches”, which operate with various types of communication media. Thickwire, thinwire, twisted pair, and optical fiber are examples of media which has been used for computer networks. Switches, as they relate to computer networking and to ethernet, are hardware-based devices which control the flow of data packets or cells based upon destination address information which is available in each packet. A properly designed and implemented switch should be capable of receiving a packet and switching the packet to an appropriate output port at what is referred to wirespeed or linespeed, which is the maximum speed capability of the particular network. Basic ethernet wirespeed is up to 10 megabits per second, Fast Ethernet is up to 100 megabits per second, and Gigabit Ethernet is capable of transmitting data over a network at a rate of up to 1,000 megabits per second. The newest Ethernet is referred to as 10 Gigabit Ethernet and is capable of transmitting data over a network at a rate of up to 10,000 megabits per second. As speed has increased, design constraints and design requirements have become more and more complex with respect to following appropriate design and protocol rules and providing a low cost, commercially viable solution.

Referring to the OSI 7-layer reference model discussed previously, the higher layers typically have more information. Various types of products are available for performing switching-related functions at various levels of the OSI model. Hubs or repeaters operate at layer one, and essentially copy and “broadcast” incoming data to a plurality of spokes of the hub. Layer two switching-related devices are typically referred to as multiport bridges, and are capable of bridging two separate networks. Bridges can build a table of forwarding rules based upon which MAC (media access controller) addresses exist on which ports of the bridge, and pass packets which are destined for an address which is located on an opposite side of the bridge. Bridges typically utilize what is known as the “spanning tree” algorithm to eliminate potential data loops; a data loop is a situation wherein a packet endlessly loops in a network looking for a particular address. The spanning tree algorithm defines a protocol for preventing data loops. Layer three switches, sometimes referred to as routers, can forward packets based upon the destination network address. Layer three switches are capable of learning addresses and maintaining tables thereof which correspond to port mappings. Processing speed for layer three switches can be improved by utilizing specialized high performance hardware, and off loading the host CPU so that instruction decisions do not delay packet forwarding.

### SUMMARY OF THE INVENTION

One embodiment of the invention includes a table search device. The device can include a table that has a plurality of entries and a cache having a subset of entries of the plurality of entries of the table. A search engine is configured to first search the cache in a first number of search cycles and then search the table in a second number of search cycles based on search results of the cache. The search engine connected to the table and the cache.

The invention in another embodiment includes a table search system. The system has a table means for storing a plurality of entries and a cache means for storing a subset of entries of the plurality of entries of the table means. A search engine means initially searches the cache means in a first number of search cycles and then searches the table means in a second number of search cycles based on search results of the cache means.

In another embodiment, the invention includes a method for performing a table lookup. The method has the steps of creating a table having a plurality of entries and creating a cache having a subset of entries of the plurality of entries of the table. The cache is searched in a first number of search cycles, and then the table is searched in a second number of search cycles based on search results of said cache.

The invention in another embodiment includes a network switch having an ARL table having a plurality of entries and an ARL cache having a subset of entries of the plurality of entries of the ARL table. A search engine is configured to first search the ARL cache in a first number of search cycles and then search the ARL table in a second number of search cycles based on search results of the ARL cache. The search engine is connected to the ARL table and the ARL cache.

### BRIEF DESCRIPTION OF THE DRAWINGS

The objects and features of the invention will be more readily understood with reference to the following description and the attached drawings, wherein:

FIG. 1 is an illustration of an 8K Table connected to a Search Engine;

FIG. 2 is an illustration of a 16K Table connected to a search Engine;

FIG. 3 is an illustration of an 8K Table with a 64 Entry Cache according to the invention;

FIG. 4 is an illustration of a 16K Table with a 128 Entry Cache according to the invention; and

FIG. 5 is a flow diagram of one example of a method of the invention.

FIG. 6 is an illustration of a network switch having an ARL search table and ARL Cache in accordance with the invention.

### DETAILED DESCRIPTION OF THE PREFERRED EMBODIMENTS

The present invention is drawn to the search of tables. In one example, tables can store address information. For example, if a network switch has eight ports, ports one through eight, and a packet coming from an address A is received in port two of the switch, an entry in the table could associate address A with port two of the switch. Therefore if a packet is received in port six of the switch and is to be sent to address A, a table lookup can be performed to determine which port is associated with address A. This table lookup can be referred to as address resolution (ARL). In the present example, the table will indicate that port two is associated with address A and that the packet should be sent to port two of the switch. If, for example, address A is not found in the table, the packet in some cases will be sent to all ports of the switch thereby decreasing the performance of the switch. However, even if a table is utilized to associate given ports with addresses, the time it takes to search a table can also negatively affect the performance of the switch.

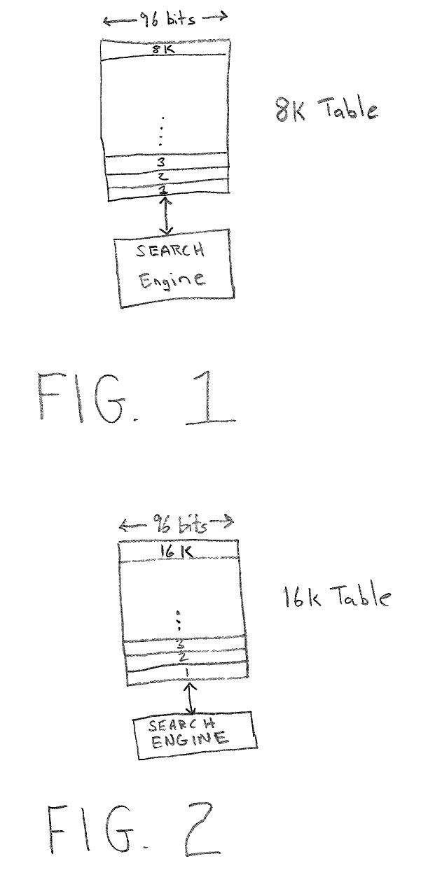

FIG. 1 is an illustration of an 8K Table that is 96 bits wide. The table is connected to a search engine which can locate specific entries in the table. As discussed above in order to be efficient, it is important to search the 8K Table as quickly as possible. For example, if the search of entries in an address table such as a Layer 2 address table could be accelerated, the transmission of packets through a network switch could be accelerated by sending a packet directly to a destination port without sending the packet to multiple ports or performing lengthy lookups.

Thirteen bits are necessary to address the 8K table as illustrated in FIG. 1 (213=8K). Therefore when a packet requires an address lookup it will take at least thirteen search cycles in order to lookup an address. First the Search Engine can be configured to split the 8K Table in half into an upper half and a lower half by determining if the most significant bit is set or not set. If the most significant bit is set then this will indicate that only the upper half of the table must be searched. If the most significant bit is not set then this will indicate that only the lower half of the must be searched. The Search Engine can then be configured to determine if the next significant bit is set. This in effect will split the remainder of the 8K Table to be searched, either the upper half or the lower half, in half into an upper quarter and a lower quarter. If the next significant bit is set the upper quarter must be searched. If the next significant bit is not set the lower quarter must be searched. This process will continue until the entry is found. In this example since there are thirteen bits needed to address the 8K Table, it will take at most thirteen search cycles to find a specific entry.

FIG. 2 is an illustration of a 96 bit wide 16K Table having 16K entries. The 16K Table is connected to a Search Engine and functions basically in the same fashion as described above in relation to the 8K Table. The basic difference is that it will take more search cycles to search a 16K Table than an 8K Table. For example, a 16K Table having 16K entries as depicted in FIG. 2 will need fourteen bits to access the 16K Table (214=16K). Therefore it will take at most 14 search cycles in order to lookup a specific entry in the 16K Table. As previously discussed, it will take at most thirteen search cycles to find a specific entry in an 8K Table. Thus, it will take one more search cycle to search a 16K Table than an 8K Table.

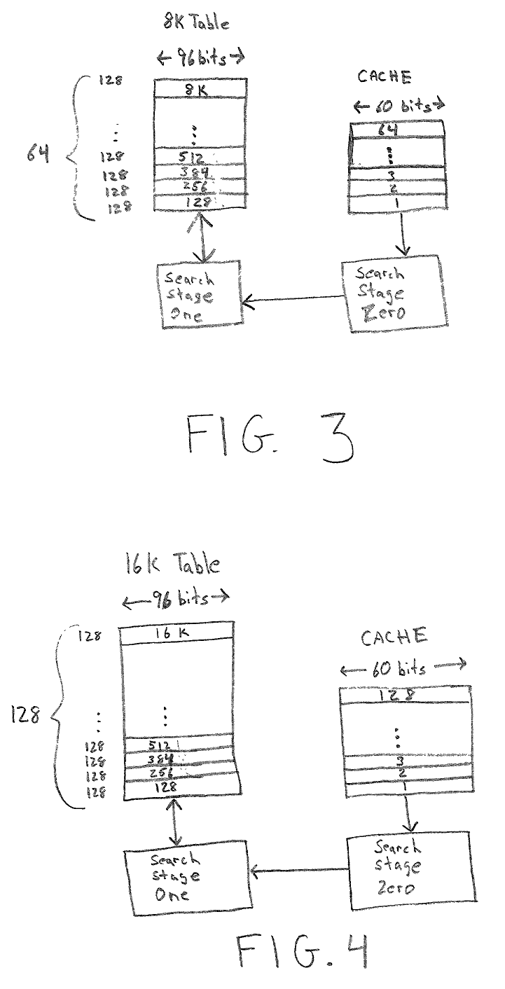

FIG. 3 is an illustration of a 60 bit wide 64 entry Cache used to lookup entries in an 8K Table of the invention. The Cache is connected to a Search Stage Zero. A Search Stage One is connected to the Search Stage Zero and is also connected to an 8K Table. The Search Stage Zero is connected to the Cache and searches the Cache. The 64 entry Cache, as depicted in FIG. 3, can store every 128^{th} entry of the larger 8K Table which can be an L2 table. When a packet requires an address lookup, each lookup can take at most thirteen search cycles. In the scheme illustrated in FIG. 3, the Search Stage Zero accesses the Cache and performs the first six search cycles. Based on the results of the search performed by accessing the Cache, the Search Stage One accesses the larger 8K Table to perform the remaining seven search cycles. When Search Stage One accesses the larger 8K Table, the Cache will be free to be accessed by the Search Stage Zero to perform another six search cycles for another lookup. This can be referred to as a pipelined approach where accessing the Cache can be referred to as the initial pipe or pipe stage and accessing the 8K Table can be referred to as the second pipe or pipe stage. An advantage of this pipelined approach is that two lookups can be performed simultaneously. One lookup is performed by the Search Stage Zero by accessing the Cache and another lookup is performed by the Search Stage One by accessing the 8K Table. Since the search of the 8K Table will be completed after seven search cycles, each lookup in this embodiment can take at the most seven search cycles each.

The rate at which a packet is processed is referred to as the throughput. In the present invention it can take up to fourteen clocks to process any individual packet. However, each of the packet lookups can be completed at a rate of seven clocks giving a throughput of a lookup every seven clocks. This can be accomplished by processing two lookups at the same time by having two lookups in a pipeline at any given time. Since there can be two lookups in the pipeline at any given time, the throughput can double and it will only take seven clocks for a packet lookup to be completed. Thus although it can take fourteen clocks for a packet to make it through the pipeline, it will only take seven clocks for a packet lookup to be completed thereby increasing the throughput.

The performance advantage of completing a search of an 8K table in seven search cycles instead of thirteen search cycles stems from being able to start one lookup while another lookup is being completed.

This pipelined approach of the invention provides a further advantage in that it eliminates the need to start two binary searches at the same time in order to realize the performance advantage of completing a search of an 8K table in seven search cycles instead of thirteen search cycles. In this pipelined approach, the performance advantage can be realized by performing a lookup for one packet and then starting another lookup for another packet several clocks latter. This is because a search cannot begin, in this embodiment, until the Search Stage Zero is finished accessing the Cache. In the example of an 8K Table having a 64 entry Cache, it will take at most six search cycles before Search Stage Zero is finished accessing the Cache. Therefore since the next search cannot start before Search Stage Zero is finished accessing the Cache, it will take at most 6 search cycles, in this example, before the next search can begin. Thus, a first search can begin and the next search can be received several search cycles later while still realizing the performance advantage of completing a search of an 8K table in seven search cycles instead of thirteen search cycles.

If a burst of packets arrive and need lookups, this will result in several packets being placed in a queue waiting for address resolution. The performance will be bounded by the slowest pipe stage. In the case where a lone packet is received and both destination and source address lookups are to be performed, the address lookups will take just as long as other schemes.

If a lone packet requires source and destination lookups, then the search with or without the use of a cache takes log₂(table size) comparisons for both source and destination lookups, which translates into 30 clock cycles per packet for a table size of 8K.

The performance of a lookup in an 8K Table using a 64 entry cache is calculated as follows:

Performance=[T₀+T₁]* (2 clocks/search cycle)+overhead

where T₀=number of search cycles in search stage zero; and

T₁=number of search cycles in search stage one.

P₈ₖ=[6+7]* 2+4=30 clocks per packet

Therefore in the case where a lone packet is received and must perform both destination and source address lookups, it will take 30 clocks per packet to do a lookup in a switch with an 8K Table using a 64 entry cache.

In the case where multiple packets are waiting for address lookups and ignoring the latency of filling the pipe with the first packet, the performance can be represented as follows:

Performance=[max(T₀, T₁) * (2 clocks/search cycle)

where T₀=number of search cycles in search stage zero

=log₂(cache table size); and

T₁=number of search cycles in search stage one

=log₂(table size/cache table size).

If the Cache table is 64 entries deep:

P₈ₖ=[max(6,7)]* 2=14 clocks per packet.

If the Cache is 128 entries deep:

P₈ₖ=[max(7, 6)]* 2=14 clocks per packet.

Thus from the above, it is evident that it does not matter whether a Cache table that is 64 entries deep or 128 entries deep is used. In either case it will take fourteen clocks per packet to do a lookup. However, using a cache of 128 entries deep increases the cache size while maintaining the same time to do a lookup, fourteen clocks per packet. Therefore in some cases, it can be more advantageous to use a Cache table that is 64 entries deep when doing lookups in an 8K Table in order to use up less space and memory associated with having a 128 entry Cache. It is understood that the above is merely an example of the sizes that could be used in one embodiment of the invention and it is obvious to one skilled in the art that the invention is not limited to the sizes disclosed above but other sizes can be used.

FIG. 4 is an illustration of a 60 bit wide 128 entry Cache used to lookup entries in a 16K Table of the invention. The Cache is connected to a Search Stage Zero. A Search Stage One is connected to the Search Stage Zero and is also connected to a 16K Table. The Search Stage Zero is connected to the Cache and searches the Cache. The 128 entry Cache, as depicted in FIG. 4, can store every 128^{th} entry of the larger 16K Table which can be an L2 table. When a packet requires an address lookup, each lookup can take at most fourteen search cycles. In the scheme illustrated in FIG. 4, the Search Stage Zero accesses the Cache and performs the first seven search cycles. Based on the results of the search performed by accessing the Cache, the Search Stage One accesses the larger 16K Table to perform the remaining seven search cycles. At this time, the Cache will be free to be accessed by the Search Stage Zero to perform another lookup, which can take a maximum of seven search cycles. Thus, two lookups can be performed simultaneously. One lookup is performed by the Search Stage Zero by accessing the Cache and another lookup is performed by the Search Stage One by accessing the 16K Table. Since the search of the 16K Table will be completed after seven search cycles, each lookup in this embodiment can take at the most seven search cycles each.

A performance advantage of completing a search of a 16K table in seven search cycles instead of thirteen search cycles stems from being able to start one lookup while another lookup is being completed.

This pipelined approach of the invention provides a further advantage in that it eliminates the need to start two binary searches at the same time in order to realize the performance advantage of completing a search of an 16K table in seven search cycles instead of fourteen search cycles. In this pipelined approach the performance advantage can be realized by performing a lookup for one packet and then starting another lookup for another packet several clocks latter. This is because a search cannot begin until the Search Stage Zero is finished accessing the Cache. In the example of an 16K Table having a 128 entry Cache, it will take at most seven search cycles before Search Stage Zero is finished accessing the Cache. Therefore since the next search cannot start before Search Stage Zero is finished accessing the Cache, it will take at most seven search cycles before the next search can begin. Thus, a first search can begin and the next search can be received several search cycles later while still realizing the performance advantage of completing a search of an 16K table in seven search cycles instead of fourteen search cycles.

If a burst of packets is received and lookups must be performed, this will result in several packets being stored in a queue waiting for address resolution. The performance will be bounded by the slowest pipe stage. In the case where a lone packet is received and must perform both destination and source address lookups, the address lookups will take just as long as other schemes.

If a lone packet requires source and destination lookups, then the search without or without the use of a cache can take log₂(table size) comparisons for both source and destination lookups, which translates into 32 clock cycles per packet for a table size of 16K.

The performance can be calculated as using the formula in paragraph 20 as follows.

P₁₆ₖ=[7+7]* 2+4=32 clocks per packet

Therefore where a lone packet is received in a switch and both destination and source address lookups need to be perforemd, it will take 32 clocks per packet to do a table lookup of a 16K Table with a 128 entry Cache.

In the case where multiple packets are waiting for address lookups and ignoring the latency of filling the pipe with the first packet, the performance can be calculated using the formula in paragraph 26 as follows.

If the Cache table is 64 entries deep:

P₁₆ₖ=[max(6, 8)]* 2=16 clocks per packet.

If the Cache is 128 entries deep:

P₁₆ₖ=[max(7, 7)]* 2=14 clocks per packet.

Thus from the above, it is evident that it can be preferable to have a Cache having 128 entries instead of a Cache having 64 entries when doing lookups in a 16K Table because lookups can be performed faster using a Cache having 128 entries. The performance of a Cache having 64 entries is 16 clocks per packet whereas the performance of a Cache having 128 entries is 14 clocks per packet. Therefore it can be preferable when performing lookups in a 16K Table to use a Cache with 128 entries in order to have a performance lookup speed of fourteen clocks per packet. It is understood that the above is merely an example of the sizes that could be used in one embodiment of the invention and it is obvious to one skilled in the art that the invention is not limited to the sizes disclosed above but other sizes can be used.

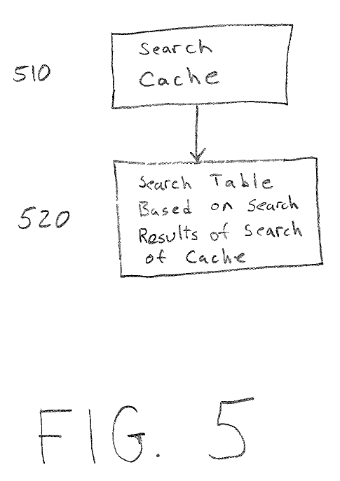

FIG. 5 is a flow diagram. In step 510 lookups are performed in a cache. In step 520 lookups are performed in a Table based on the lookup results performed in the Cache. The Table can be of any size and can in some cases be an 8K Table or a 16K Table. In any case, the table will have a plurality of entries. For instance the 8K Table can have 8K entries and the 16K Table can have 16K entries. The Cache has a subset of entries found in the Table. For instance, the Cache can have 64 entries. If the Cache is being used with an 8K Table, the Cache could be made up of every 128^{th} entry in the 8K Table. If the Cache had 128 entries and was being used with a 16K Table, the Cache could also be made up of every 128^{th} entry in the 16K Table. It is noted that although the Cache as described is made up of every 128^{th} entry in both the 8K Table and 16K Table, the invention is not limited to which entries in the table the Cache is made up of. For example, the Cache could be made up of entry 5, 256, 300 etc. until all entries in the Cache are filled.

FIG. 6 is an illustration of a network switch in accordance with one embodiment of the invention. The switch can for example have eight ports 601, 602, 603, 604, 605, 606, 607 and 608. As each of the ports receive a packet, address resolution (ARL) is performed by the ARL Logic. The ARL Logic can have an ARL Table which stores a list of ports with associated addresses. The ARL Cache can hold a subset of the list to help direct a more specified search in the ARL Table.

In this example, when a packet is received in a port, a lookup is performed for the packet to determine which port the packet should be sent to. For example, if a packet is received at port 606 and has a destination address of B which corresponds to port 603, address resolution can be performed for the packet by the ARL Logic. The ARL Table can have entries showing which addresses are associated with which ports. In the present example, if port 603 was associated with address B, when the packet was received in port 606 it would have a destination address of B. The destination address B would be looked up in the ARL Cache by the Search Stage Zero of the ARL Logic. Search Stage One can continue the lookup based on the search of the ARL Cache by the Search Stage Zero which can designate a specific segment of the ARL Table to complete the lookup for address B. The result can be for example that the ARL Table has an entry that shows that port 603 corresponds to address B. Therefore the packet can be sent directly to port 603.

The above-discussed configuration of the invention is, in a preferred embodiment, embodied on a semiconductor substrate, such as silicon, with appropriate semiconductor manufacturing techniques and based upon a circuit layout which would, based upon the embodiments discussed above, be apparent to those skilled in the art. A person of skill in the art with respect to semiconductor design and manufacturing would be able to implement the various modules, interfaces, and tables, buffers, etc. of the present invention onto a single semiconductor substrate, based upon the architectural description discussed above. It would also be within the scope of the invention to implement the disclosed elements of the invention in discrete electronic components, thereby taking advantage of the functional aspects of the invention without maximizing the advantages through the use of a single semiconductor substrate.

Although the invention has been described based upon these preferred embodiments, it would be apparent to those of skilled in the art that certain modifications, variations, and alternative constructions would be apparent, while remaining within the spirit and scope of the invention. In order to determine the metes and bounds of the invention, therefore, reference should be made to the appended claims.

We claim:

1. A table search device comprising:
a table having a plurality of entries;
a cache having a subset of entries of said plurality of entries of said table; and
a search engine configured to first search said cache in a first number of search cycles and then search said table in a second number of search cycles based on search results of said cache, said search engine connected to said table and said cache.

2. The device as recited in claim 1 wherein said search engine comprises:
a search stage zero segment configured to search said cache in said first number of search cycles, said search stage zero segment connected to said cache; and
a search stage one segment configured to search said table in a second number of search cycles based on search results of said cache, said search stage one segment connected to said search stage zero segment and said table.

3. The device as recited in claim 1 wherein:
said first number of search cycles is less than said second number of search cycles.

4. The device as recited in claim 1 wherein:
said first number of search cycles is equal to said second number of search cycles.

5. The device as recited in claim 2 wherein:
said first number of search cycles is less than said second number of search cycles.

6. The device as recited in claim 2 wherein:
said first number of search cycles is equal to said second number of search cycles.

7. A table search system comprising:
a table means for storing a plurality of entries;
a cache means for storing a subset of entries of said plurality of entries of said table means; and
a search engine means for initially searching said cache means in a first number of search cycles and then searching said table means in a second number of search cycles based on search results of said cache means.

8. The system as recited in claim 7 wherein said search engine means comprises:
a search stage zero segment means for searching said cache means in said first number of search cycles, said search stage zero segment means being connected to said cache means; and
a search stage one segment means for searching said table means in said second number of search cycles based on search results of said cache means, said search stage one segment means being connected to said table and said search stage zero means.

9. The system as recited in claim 7 wherein:
said first number of search cycles is less than said second number of search cycles.

10. The system as recited in claim 7 wherein:
said first number of search cycles is equal to said second number of search cycles.

11. The system as recited in claim 8 wherein:
said first number of search cycles is less than said second number of search cycles.

12. The system as recited in claim 8 wherein:
said first number of search cycles is equal to said second number of search cycles.

13. A method for performing a table lookup comprising the steps of:
creating a table having a plurality of entries;
creating a cache having a subset of entries of said plurality of entries of said table;
searching said cache in a first number of search cycles; and
searching said table in a second number of search cycles based on search results of said cache.

14. The method as recited in claim 13 wherein:
said first number of search cycles used to search said cache is less than said second number of search cycles used to search said table.

15. The method as recited in claim 13 wherein:
said first number of search cycles used to search said cache is equal to said second number of search cycles used to search said table.

16. A network switch comprising:
an ARL table having a plurality of entries;
a ARL cache having a subset of entries of said plurality of entries of said ARL table; and
a search engine configured to first search said ARL cache in a first number of search cycles and then search said ARL table in a second number of search cycles based on search results of said ARL cache, said search engine connected to said ARL table and said ARL cache.

17. The network switch as recited in claim 16 wherein said search engine comprises:
a search stage zero segment configured to search said ARL cache in said first number of search cycles, said search stage zero segment connected to said ARL cache; and
a search stage one segment configured to search said ARL table in a second number of search cycles based on search results of said ARL cache, said search stage one segment connected to said search stage zero segment and said ARL table.

18. The network switch as recited in claim 16 wherein:
said first number of search cycles is less than said second number of search cycles.

19. The device as recited in claim 16 wherein:
said first number of search cycles is equal to said second number of search cycles.

20. The network switch as recited in claim 17 wherein:
said first number of search cycles is less than said second number of search cycles.

21. The network switch as recited in claim 17 wherein:
said first number of search cycles is equal to said second number of search cycles.
